(19) United States
(12) Patent Application Publication
(10) Pub. No.: US 2015/0306843 A1
(43) Pub. Date: Oct. 29, 2015

(54) Durable Stick-On Patch for Clothing and Other Items

(71) Applicant: EASY PEASY PATCHES, INC., TORONTO (CA)

(72) Inventors: Mark White, Toronto (CA); Andrea Winarski, Toronto (CA)

(73) Assignee: EASY PEASY PATCHES, INC., Toronto (CA)

(21) Appl. No.: 14/260,271

(22) Filed: Apr. 23, 2014

(51) Int. Cl. B32B 5/02; B32B 38/00; B32B 7/12; B32B 37/16

(52) U.S. Cl. CPC B32B 5/024; B32B 37/16; B32B 38/0004; B32B 38/145; B32B 7/12; B32B 2250/03; B32B 2262/0276; B32B 2556/00; B32B 2437/00

(57) ABSTRACT

A durable stick-on patch made from a fabric-like polymer substrate, such as woven polyester, on which a design or information has been printed, by joining the substrate with a fabric adhesive having a backing using a standard laminating device, where individual stick-on patches are cut from the resulting patch-roll and can be applied to clothing or other items at room temperature.

### TECHNICAL FIELD

The invention relates to the field of stick-on patches for clothing and other items.

### BACKGROUND OF THE INVENTION

Patches, in one form or another, are as old as woven fabric. When a garment or other item made from fabric or fabric-like material is damaged, as with a tear or burn, it is often desirable to mend or repair the damaged portion instead of replacing the item. Mending or repair can involve sewing or gluing the damaged portion or affixing a patch over it to reinforce it and prevent further damage. Patching typically involves the application of a relatively small section of fabric or other material over the damaged area along with a means of securing the patch. Patches are often made from material similar to that from which the damaged item is made, as with denim used to patch denim jeans or sailcloth to patch a sail. Patches can also be made from material different from that of the patched item, as with durable patches used to cover areas of a garment likely to encounter wear and tear.

Contemporary patches are not limited to utilitarian purposes, they can also be used to convey information, such as a uniform patch with a name or insignia, or to enhance the appearance of a garment, as with a patch containing an artistic design. The relevant information or design can be sewn or embroidered onto the patch itself, or it can be printed onto the patch using a variety of techniques, such as screen printing or ultraviolet printing, appropriate for the material and the desired design.

There are various techniques that can be used to apply a patch to a garment or item. One common approach is to sew the patch on, with thread or fiber physically securing it in place. This can be a suitable solution for many applications, but it requires sewing materials, some minimal sewing skill, and access to the back or interior side of the item being patched for proper stitching

Another approach to patching is applying the patch via an adhesive that affixes the patch to the garment or item being patched. The adhesive is typically imparted onto the patch material during manufacturing, and the adhesive sheet will typically have a backing that can be pulled off to apply the patch to the garment or item in need of patching While applying a patch via adhesive is generally simpler than sewing the patch on, special handling, such as ironing, may be required to activate or fix the adhesive to the item being patched. The need for an iron, as with iron-on patches, can limit the material from which the patch can be made, as heat from an iron can distort the patching material. Additionally, irons can potentially distort any information or design imparted onto the patch during manufacturing, because excess heat can melt the printed ink or dye. Also, iron-on patches require access to an iron and an electrical outlet, and such items may not be available when, for example, camping or traveling.

Thus, a difficultly with traditional adhesive-based patches, particularly those that have lettering or designs, is finding a suitable balance between: 1) the composition of the patch substrate, which needs to be durable and capable of accepting both the adhesive and ink or dye, 2) the strength and generality of the adhesive, which ideally permits the patch to be used with a variety of fabrics or materials and does not weaken or fall off when stressed or subjected to harsh conditions, and 3) the extent and convenience of any treatment, such as ironing, to promote a durable connection between the patch and the underlying fabric or material while not distorting any printing on the patch. Further, the manner of combining the patch substrate and adhesive and imparting the information or design must be suitable for volume manufacturing with limited rejects. Finally, the end product of the manufacturing process must be suitable for cutting into a variety of shapes and sizes such that the information or design is not distorted, the adhesive properties of the patch are not compromised, and the cut patches can be conveniently handled, stored, and shipped without, e.g., damage to the backing or excess seepage of the adhesive from the edges of the cut patches.

### SUMMARY OF THE INVENTION

The applicant currently markets a version of the adhesive patch of the present invention under the trade name Easy Peasy Patches. Easy Peasy Patches are superior to a prior adhesive patch developed by the present inventors and offered for sale under the trade name “Grab a Scab.” Grab a Scab patches used different materials and an inferior manufacturing process. Specifically, Grab a Scab patches were made from a vinyl polymer that was less durable than the knit polyester polymer favored for the present invention. Additionally, the vinyl polymer was not as well suited to accepting printed information or designs, and the printing had a tendency to distort and fade. Further, the patches had a lower shelf life due to the prior adhesive used. As a result of extensive experimentation the current invention improves upon the prior Grab a Scab product across multiple dimensions.

In an effort to improve upon the Grab a Scab product, the present inventors conducted significant testing to determine a suitable combination of patch material, adhesive, printing process, and cutting process to design a patch with desirable characteristics. Specifically, the inventors tested a number of materials for the patch substrate and determined that a polyester knit polymer was durable and well-suited to printing via common dye sublimation printers, particularly those that use a heat transfer printing process, and also capable of accepting adhesive without excessive congealing, lumping, or diffusion during manufacturing or storage. The currently favored knit polymer fabric is sold by Grimco Inc. under the trade name Aberdeen Soft Knit. Aberdeen Soft Knit is a 100% woven polyester fabric of 0.45 mm thickness that is well-adapted for use in dye sublimation printing and is often used for signage. It is durable but relatively light and flexible, making it suitable for a variety of patching applications.

The decision to use a woven polymer fabric as the patch material was made in connection with experiments to find a suitable adhesive. After experimenting with a number of different adhesives from major manufacturers, it was determined that a product offered by Therm O Web Adhesives under the trade name PeelnStick™ Instant Bond Fabric Fuse offers significant advantages over the previous adhesive used with Grab a Scab patches with regard to patch effectiveness, durability, shelf life, and ease of manufacturing. Specifically, it was found that PeelnStick™ Instant Bond Fabric Fuse could be joined with the printed polyester patch material without distorting the printing or interfering with the adhesive properties of the patch itself After experimentation, it was determined the printed polyester fabric could be joined with the adhesive in a standard laminating device at an elevated temperature of approximately 35° C. to 50° C. (95° F. to 122° F.) while not distorting the design or interfering with the adhesive properties of the patch.

The indicated adhesive is particularly well-suited to patching applications because, unlike iron-on patches, it can be applied at room temperature. While the inventors have achieved best results by tumble-drying newly-patched items for approximately 10 minutes after patch application and allowing them to cure for 24 hours, the character of the adhesive and its interaction with the polyester fabric substrate are such that patches can be effectively applied at room temperature (approximately 20° C. to 25° C.) and below. Patches applied to clothing at room temperature have been found to hold-up over 30 washer-dryer cycles.

The effort to improve upon the composition and construction of the prior Grab a Scab patch also involved using a new printing method and inks for the present invention. Specifically, after experimenting with screen printing and UV printing, the current manufacturing process employing 4-color CMYK dye sublimation heat transfer printer was adopted. It has been found that dye sublimation printing results in superior vividness and durability for designs printed on the woven polymer patch material. Digistar brand inks sold by Kiian have been found to be particularly suitable for the printing. Other dye sublimation printing processes and inks would likely also yield acceptable results.

As indicated, the manufacturing process of the present invention involves dye sublimation printing onto a polyester fabric substrate and bonding the printed polyester to the fabric adhesive at elevated temperature. These processes are carried out using standard industrial printing and laminating equipment, and the overall process has been found to result in a product superior to the vinyl-based process used to manufacture Grab a Scab.

Another obstacle that had to be overcome in creating the present invention was developing a suitable method of cutting the final patches from the finished roll of patch material. Specifically, it was found that cutting patches from the roll using standard die-based cutting tended to distort the designs on the patches, resulting in an unacceptable product loss. To overcome this problem, the inventors discovered that it is desirable to use a camera-guided cutter, particularly one that uses a laser, where individual patches can be cut from the patch roll under a degree of control and supervision. This process ensures that the finished patch roll is not distorted during cutting and the final patches have the desired design. Camera-guided cutting also has the benefit of permitting complex patch shapes, not simply circles and regular polygons, that conform to the printed designs.

### BRIEF DESCRIPTION OF THE DRAWINGS

A more complete and thorough understanding of the present embodiments and advantages thereof may be acquired by referring to the following description taken in conjunction with the accompanying drawings, wherein:

FIG. 1 is a side view of a stick-on patch according to the present invention showing the polymer substrate, the adhesive layer, and the peel-away backing.

FIG. 2 is a top view of a stick-on patch according to the present invention with non-uniform perimeter that can be cut from the completed patch-roll using a camera-guided cutter.

### DETAILED DESCRIPTION OF THE DRAWINGS

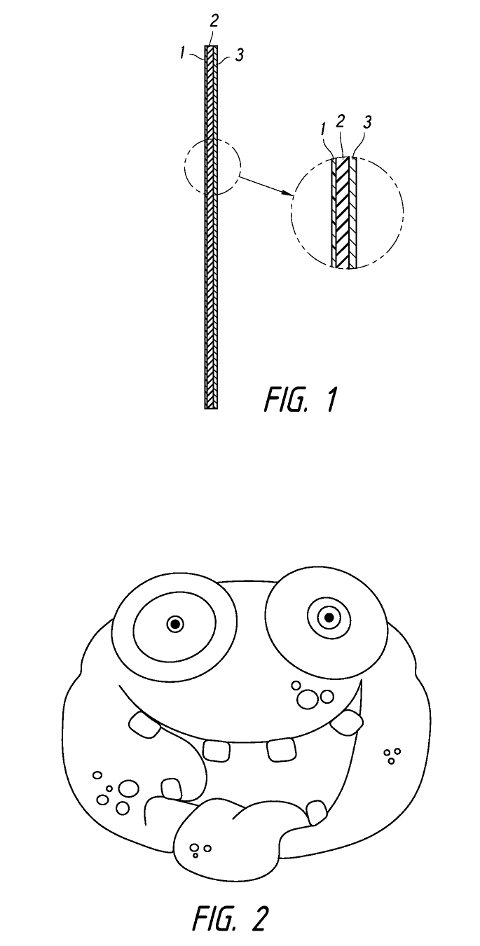

One embodiment of the present invention is illustrated in FIG. 1, which shows a side view of the stick-on patch prior to application. The adhesive backing layer 1 covers the adhesive 2, which has been joined with the patch substrate 3 in a laminating device. The adhesive backing 1 typically comes with the adhesive and is peeled away by the user to affix the patch to the desired item.

FIG. 2 shows a patch with a printed design. The patch is cut from the manufactured patch roll in a manner that follows the contour of the design. The inventors have discovered that using a camera-guided cutting device, rather than, e.g., a dye stamp, is a preferable way to produce patches with a perimeter that follows the contour of the design. Such camera-cut patches are more appealing than, e.g., circular or rectangular patches with a design printed on some of the patch area.

It should be noted the stick-on patches of the present invention have a variety of uses beyond simply patching clothing or other items made from fabric. They can be also used as fashion accessories for undamaged clothing or for other goods, such as backpacks or water bottles. The stick-on patches can also be used as decor for rooms, automobiles, toys, or other items, as with crafting projects. They can also be used to repair outdoor equipment such as tents and awnings. The characteristics of the stick-on patch render it suitable for a variety of uses limited only by the imagination of the user.

Modifications and substitution by one of ordinary skill in the art are considered to be within the scope of the present invention, which is not limited except by the following claims.

What is claimed is:

1. A stick-on patch comprising:
a fabric-like substrate made from a woven polymer, such as polyester;
a fabric adhesive with a backing;
wherein a design or other information is printed on the fabric-like substrate; and
wherein the fabric-like substrate and adhesive are joined in a laminating device to form a patch-roll; and
the stick-on patch is cut from the patch-roll; and
the stick-on patch can be applied at approximately room temperature.

2. The stick-on patch of claim 1, where the patch is cut from the patch-roll using a camera-guided cutting device.

3. The stick-on patch of claim 1, where the fabric-like substrate and fabric adhesive are joined in a laminating device at an elevated temperature of approximately 35° C. to 50° C.

4. The stick-on patch of claim 1, where the design or information is printed on the fabric-like substrate using a dye sublimation printer.

5. The stick-on patch of claim 2, where the camera-guided cutting device uses a laser for cutting.

6. The stick-on patch of claim 2, where the design or information is printed on the fabric-like substrate with a dye sublimation printer.

7. The stick-on patch of claim 2, where the fabric-like substrate and fabric adhesive are joined in a laminating device at an elevated temperature of approximately 35° C. to 50° C.

8. The stick-on patch of claim 6, where the fabric-like substrate and fabric adhesive are joined in a laminating device at an elevated temperature of approximately35° C. to 50° C.

9. A method of manufacturing stick-on patches comprising:
printing a design or other information on a fabric-like substrate made from a woven polymer, such as polyester;
joining the fabric-like substrate with a fabric adhesive with a backing in a laminating device to form a patch-roll;
cutting the stick-on patches from the patch-roll;
such that the stick-on patches can be applied at approximately room temperature.

10. The method of manufacturing stick-on patches of claim 9, where the stick-on patches are cut from the patch-roll using a camera-guided cutting device.

11. The method of manufacturing stick-on patches of claim 9, where the fabric-like substrate and fabric adhesive are joined in a laminating device at an elevated temperature of approximately 35° C. to 50° C.

12. The method of manufacturing stick-on patches of claim 9, where the design or information is printed on the fabric-like substrate using a dye sublimation printer.

13. The method of manufacturing stick-on patches of claim 10, where the camera-guided cutting device uses a laser to cut the patches from the patch-roll.

14. The method of manufacturing stick-on patches of claim 10, where the fabric-like substrate and fabric adhesive are joined in a laminating device at an elevated temperature of approximately 35° C. to 50° C.

15. The method of manufacturing stick-on patches of claim 10, where the design or information is printed on the fabric-like substrate using a dye sublimation printer.

16. The method of manufacturing stick-on patches of claim 15, where the fabric-like substrate and fabric adhesive are joined in a laminating device at an elevated temperature of approximately 35° C. to 50° C.

17. The method of manufacturing stick-on patches of claim 16, where the camera-guided cutting device uses a laser to cut the patches from the patch-roll.
